(19) United States
(12) Patent Application Publication
(10) Pub. No.: US 2023/0145747 A1
(43) Pub. Date: May 11, 2023

(54) ACTUATION-ASSISTED PUMP VALVE

(71) Applicant: SPM Oil & Gas Inc., Fort Worth, TX (US)

(72) Inventors: Ralph E. HARRIS, Fort Worth, TX (US); Joe Allen SUTTON, Weatherford, TX (US)

(73) Assignee: SPM Oil & Gas Inc., Fort Worth, TX (US)

(21) Appl. No.: 17/905,469

(22) PCT Filed: Mar. 1, 2021
(86) PCT No.: PCT/US2021/020357

§ 371 Date: Sep. 1, 2022

Related U.S. Application Data
(60) Provisional application No. 62/984,094, filed on Mar. 2, 2020.

(51) Int. Cl. E21B 43/26; F04B 53/00; F04B 49/22; F04B 19/22

(52) U.S. Cl. CPC E21B 43/2607; F04B 53/006; F04B 49/22; F04B 19/22

(57) ABSTRACT

A reciprocating pump for a hydraulic fracking operation includes a plunger mechanically connected to a crankshaft for pumping a fluid through a cylinder, the cylinder having fluid ports for ingress and egress of fluid. An ingress valve is disposed at the ingress port, and a first actuator is coupled to the ingress valve and configured to actuate the ingress valve to be displaced between an enlarged open position to permit fluid flow through the ingress port and a closed position to prohibit fluid flow through the ingress port. An egress valve is disposed at the egress port, and a second actuator is coupled to the egress valve configured to actuate the egress valve to be displaced between an enlarged open position to permit fluid flow through the egress port and a closed position to prohibit fluid flow through the egress port.

### FIELD

This disclosure relates to a positive displacement pump, and more particularly to a frac pump with actuation-assisted valves in the fluid end.

### BACKGROUND

Hydraulic fracturing (a.k.a. fracking) is a process to obtain hydrocarbons such as natural gas and petroleum by injecting a fracking fluid or slurry at high pressure into a wellbore to create cracks in deep rock formations. The hydraulic fracturing process employs a variety of different types of equipment at the site of the well, including one or more positive displacement pumps, slurry blender, fracturing fluid tanks, high-pressure flow iron (pipe or conduit), wellhead, valves, charge pumps, and trailers upon which some equipment are carried.

### BRIEF DESCRIPTION OF THE DRAWINGS

FIG. 1 is a cross-sectional view of actuation-assisted valves within a frac pump according to the teachings of the present disclosure; and

FIG. 2 is a simplified flowchart illustrating the operations of the actuation-assisted suction and discharge valves in coordination with the plunger according to the teachings of the present disclosure.

### DETAILED DESCRIPTION

Positive displacement pumps, in particular, are commonly used in oil fields for high pressure hydrocarbon recovery applications, such as injecting the fracking fluid down the wellbore. A positive displacement pump typically has two sections, a power end and a fluid end. The power end includes a crankshaft powered by an engine that drives the plungers. The fluid end of the pump includes cylinders into which the plungers operate to draw fluid into the fluid chamber, via the intake valves, and then forcibly push out at a high pressure, via discharge valves, to a discharge manifold, which is in fluid communication with a well head. Traditionally, the valves operating in the fluid end of a high-pressure positive displacement pump designed for hydraulic fracturing operate without assistance beyond the displacement of fluid by the action of the plunger. These ingress and egress valves open and close as the pressure in the fluid chamber rises and falls with the movement of the plunger. A simple spring on top of each valve provides some resistance to valve lift and helps to control the impact forces caused by the closure of the valve. The valve is guided by either guide legs or a guide stem. A valve stop captures the valve to prevent the valve from interfering with other moving components, such as the plunger, and keeps the valve in place during operation.

The conventional valve in a frac pump opens only sufficiently to equalize the pressure across the valve. This limited movement of the valve causes the volume of fluid passing through the valve to travel at a very high velocity, estimated at greater than 55 feet per second, as the fluid is pushed through a relatively small space between the valve and the valve seat. A result of this high velocity fluid impacting the valve and the valve seat is premature erosion and damage of the valve and valve seat. Therefore, an objective of the actuation-assisted valve described herein is to reduce the fluid velocity as the fluid passes through the ingress or egress ports upon which the valve sits. One design consideration was to omit the spring that is limiting valve lift. When operated without the spring, the valve exhibited excessive impact forces. Another design option was to increase the valve size and thus increase the area of the opening through which the fluid passes. However, a valve design with sufficient size to lower the fluid velocity necessitates an immense load on the top of the oversized valve that requires excessive strength, and therefore material and weight, to support the valve seat.

An alternative option to slow down the fluid velocity by enlarging the valve opening is to lift the valve higher off of the seat. This may be accomplished by assisting the lifting action of the valve by using an actuator. No other frac pumps on the market use an assisted actuated valve to control fluid velocity passing the valve. The use of an actuated valve assembly provides a secondary control over the valve operations that ultimately leads to prolonged life of the valve and valve seat.

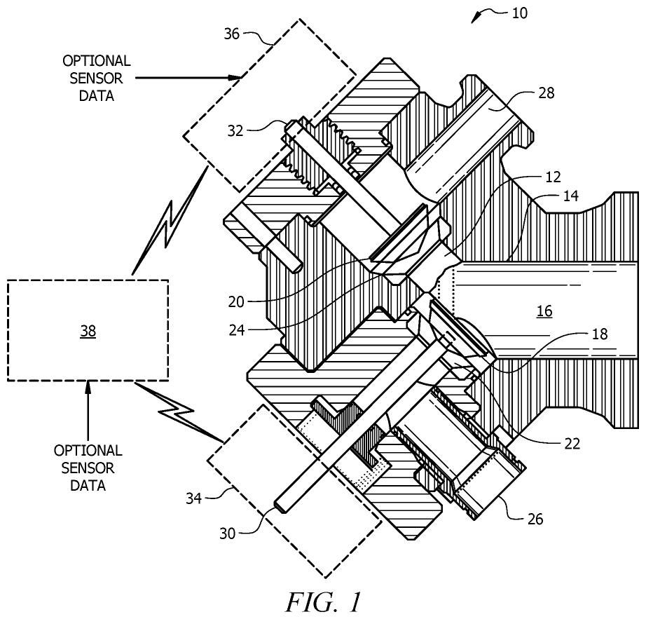

Referring to FIG. 1, a fluid end 10 of the positive displacement pump includes a fluid chamber 12 that is in communication with a plunger bore 14 in which a plunger 16 is disposed for linear actuation and displacement within the bore 14. A suction valve 18 and a discharge valve 20 are respectively disposed over a suction valve seat 22 and a discharge valve seat 24. The fluid chamber 12 is in fluid communication with a suction port 26 and a discharge port 28 controlled by the opening and closing of the suction and discharge valves 18 and 20. Suction and discharge valves 18 and 20 each has a valve stem 30 and 32 that are coupled to respective actuators 34 and 36. Both actuators are in wired or wireless communication with a controller 38. The actuation-assisted valves 18 and 20 may be actuated by using hydraulic, pneumatic, electromagnetic (a.k.a. Solenoid), and/or mechanical (e.g., cam(s) with lifter(s)) actuation. The actuators 34 and 36 are configured to control both the opening and closing displacement of the valves to reduce the flow velocity by at least 25%, for example. Further, since the valve is actuated, the guides and valve stop may no longer be needed. The functionalities of the guides and stops may be integrated into the assisted valve actuation. The impact forces are mitigated by the actuated control of the valve opening and closure operations.

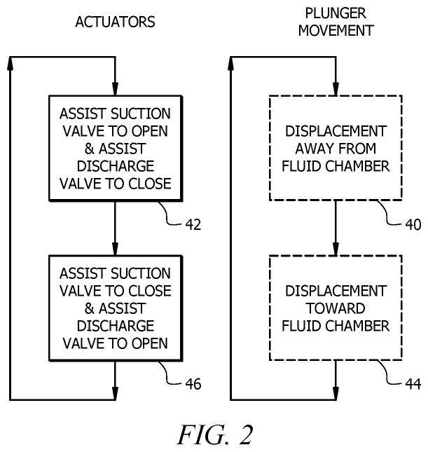

Referring to FIG. 2, in operation, the fracturing fluid is caused to flow into and out of the pump fluid chamber as the plunger reciprocates within the plunger bore away from and toward the fluid chamber. As the plunger moves away from the fluid chamber (40), the pressure inside the chamber decreases, creating a differential pressure across the suction valve 18, drawing the fracturing fluid from the suction port 26 and bypassing the open suction valve 18 into the fluid chamber. The controller 38 sends a signal to the actuator 34 to instruct it to assist in opening and elevating the suction valve 18 away from the suction valve seat 22 (42) so that the spacing between the suction valve and the suction valve seat is maintained or enlarged to enable the fluid to pass at a slower speed that results in less impact. When the plunger changes direction and begins to move towards the fluid chamber (44), the pressure inside the fluid chamber substantially increases, which causes the closing of the suction valve with assistance from the actuator 34 (46). This causes an increase in the differential pressure across the discharge valve 20 and causes the discharge valve to open, with assistance from the actuator 36 to elevate the discharge valve 20 away from the discharge valve seat 24 and enabling the highly pressurized fracturing fluid to discharge from the fluid chamber to the discharge port 28, and ultimately to the wellbore.

The controller 38 may optionally receive sensor data from one or more sensors that measure or monitor the fluid pressure, fluid speed, plunger displacement, and/or other parameters of pump operations to enable the controller to coordinate the activity of the actuators 34 and 36.

It should be noted that the actuation-assistance can be implemented to reduce fluid velocity in any valve configuration or orientation in a frac pump. For example, the valves may be oriented in a V configuration as shown in FIG. 1, or linearly along the same axis. The controller may be in in wired or wireless communication with the actuators so that they control and coordinate the operation of the suction and discharge valves with the operation and movement of the plunger and crankshaft.

The features of the present invention which are believed to be novel are set forth below with particularity in the appended claims. However, modifications, variations, and changes to the exemplary embodiments of the actuator-assisted valves for a positive displacement pump described above will be apparent to those skilled in the art, and the actuation-assisted valve described herein thus encompasses such modifications, variations, and changes and are not limited to the specific embodiments described herein.

What is claimed is:

1. A reciprocating pump for a hydraulic fracking operation, comprising:
a plunger mechanically connected to a crankshaft for pumping a fluid through a cylinder, the cylinder having fluid ports for ingress and egress of fluid, the plunger being displaced linearly between first and second positions within the cylinder;
an ingress valve disposed at the ingress port;
a first actuator coupled to the ingress valve configured to actuate the ingress valve to be displaced between an enlarged open position to permit fluid flow through the ingress port and a closed position to prohibit fluid flow through the ingress port;
an egress valve disposed at the egress port; and
a second actuator coupled to the egress valve configured to actuate the egress valve to be displaced between an enlarged open position to permit fluid flow through the egress port and a closed position to prohibit fluid flow through the egress port.

2. The pump of claim 1, further comprising a controller in communication with the first and second actuators to control and coordinate the displacement of the ingress and egress valves.

3. The pump of claim 1, further comprising a controller in communication with the first and second actuators to control the amount of an enlarged opening of the valves relative to respective valve seats.

4. The pump of claim 2, wherein the controller is in wireless communication with the first and second actuators.

5. The pump of claim 1, wherein the first and second actuators are selected from the group consisting of hydraulic, pneumatic, electromagnetic, and mechanical actuators.

6. The pump of claim 1, further comprising:
at least one sensor configured to measure a fluid pressure within the cylinder; and
a controller receiving the fluid pressure measurement from the at least one sensor and being in communication with the first and second actuators to control and coordinate the displacement of the ingress and egress valves in response to the fluid pressure measurement.

7. A positive displacement pump comprising:
a fluid passage;
a valve assembly held within the fluid passage, the valve assembly comprising a valve body configured to move between an open position spaced from a valve seat to permit fluid flow within the fluid passage and a closed position against the valve seat to prohibit fluid flow within the fluid passage; and
an actuator coupled to the valve assembly and configured to actuate the valve body to move between the open and closed positions.

8. The pump of claim 7, further comprising a controller in communication with the actuator to control and coordinate the displacement of the valve body.

9. The pump of claim 7, further comprising a controller in communication with the actuator to control the amount of displacement of the valve body relative to the valve seat.

10. The pump of claim 7, wherein the controller is in wireless communication with the first and second actuators.

11. The pump of claim 7, wherein the actuator is selected from the group consisting of hydraulic, pneumatic, electromagnetic, and mechanical actuators.

12. A reciprocating pump for a hydraulic fracking operation, comprising:
a power end comprising a crankshaft;
a plunger mechanically connected to the crankshaft for pumping a fluid through a cylinder disposed in a fluid end of the pump, the cylinder having fluid ports for ingress and egress of fluid, the plunger being displaced linearly between first and second positions within the cylinder;
an ingress valve disposed at the ingress port;
a first actuator coupled to the ingress valve configured to actuate the ingress valve to be displaced between an enlarged open position to permit fluid flow through the ingress port and a closed position to prohibit fluid flow through the ingress port;
an egress valve disposed at the egress port; and
a second actuator coupled to the egress valve configured to actuate the egress valve to be displaced between an enlarged open position to permit fluid flow through the egress port and a closed position to prohibit fluid flow through the egress port.

13. The pump of claim 12, further comprising a controller in communication with the first and second actuators to control and coordinate the displacement of the ingress and egress valves.

14. The pump of claim 12, further comprising a controller in communication with the first and second actuators to control the amount of lift of the valves relative to respective valve seats.

15. The pump of claim 12, wherein the controller is in wireless communication with the first and second actuators.

16. The pump of claim 12, wherein the first and second actuators are selected from the group consisting of hydraulic, pneumatic, electromagnetic, and mechanical actuators.

17. The pump of claim 12, further comprising:
at least one sensor configured to measure a fluid pressure within the cylinder; and
a controller receiving the fluid pressure measurement from the at least one sensor and being in communication with the first and second actuators to control and coordinate the displacement of the ingress and egress valves in response to the fluid pressure measurement.
